(19) United States
(12) Patent Application Publication
(10) Pub. No.: US 2008/0316575 A1
(43) Pub. Date: Dec. 25, 2008

(54) Aberration correction of optical traps

(75) Inventors: Jennifer E. Curtis, Chicago, IL (US); Brian A. Koss, Chicago, IL (US); David G. Grier, New York City, NY (US); Kosta Ladavac, Chicago, IL (US); Karen Kasza, Palos Park, IL (US)

Correspondence Address: AKERMAN SENTERFITT, 801 PENNSYLVANIA AVENUE N.W., SUITE 600, WASHINGTON, DC, 20004, US

(73) Assignee: THE UNIVERSITY OF CHICAGO.,, Chicago, IL (US)

(21) Appl. No.: 12/155,503

(22) Filed: Jun. 5, 2008

Related U.S. Application Data
(62) Division of application No. 10/958,591, filed on Oct. 6, 2004, now abandoned.
Application No. 10/958,591 is a continuation-in-part of application No. 10/209,730, filed on Aug. 1, 2002, now abandoned.
Application No. 10/209,730 is a continuation-in-part of application No. 10/437,689, filed on May 13, 2003, now abandoned.

(51) Int. Cl. G02F 1/01; G02B 5/18; G01B 9/00

(52) U.S. Cl. 359/279; 359/566; 356/521

(57) ABSTRACT

A method and system for correcting aberrations in a beam of light including correcting for effects from an undiffracted portion of an input beam. The method and system includes (1) a component for providing a beam of light; (2) a component for applying a diffraction grating pattern to the beam of light to establish an optical gradient to form an optical trap; (3) component for measuring aberration in the beam of light having the applied diffraction grating pattern; (4) component for calculating a phase-shifting diffraction grating encoding the aberration; and (5) component for projecting the phase-shifting diffraction grating in conjunction with the diffraction grating pattern characteristic of the optical trap. The method and system also includes (1) providing an input beam of light; (2) applying a diffractive grating pattern to the input beam of light to establish a diffracted portion, apart from an undiffracted portion, to form at least one optical trap; (3) operating on both the diffracted portion and the undiffracted portion to bring the light to focus out of the focal plane; and (4) operating on the diffracted portion of the input beam of light (the optical trap) to modify focus of the diffracted portion relative to the undiffracted portion to bring the diffracted portion into focus in the focal plane.

### CROSS-REFERENCE TO RELATED APPLICATIONS

This application is a divisional application of U.S. patent application Ser. No. 10/958,591 filed Oct. 6, 2004, which is a continuation-in-part of co-pending U.S. patent application Ser. No. 10/209,730, filed Aug. 1, 2002, and U.S. patent application Ser. No. 10/437,689, filed May 13, 2003.

The present invention relates generally to a method and apparatus for characterization of, and correction for, aberrations and other optical anomalies introduced by an optical train for production of optical traps. More particularly, the invention is concerned with a method and apparatus for aberration characterization generally and aberration correction of optical traps and to control of undiffracted portions of an input laser beam passed through a diffractive grating pattern. The present invention relates also to the use of holographic optical tweezers and control of optical trap configurations. Furthermore, this invention concerns use of particular forms of intensity patterns, such as optical vortices, to automatically correct the alignment of an optical train, correct for defects in this alignment to optimize the optical traps produced by the optical train and even generally characterize the state or condition of an optical train.

This invention was made with U.S. Government support under Contract No. UCHI-982/994 awarded by the National Science Foundation under Award No. DMR-9880595 and also National Science Foundation Grant under Award No. DMR-9730189.

### BACKGROUND OF THE INVENTION

Holographic optical tweezers (HOTs) use computer-generated diffractive grating patterns (DOEs) to create arbitrary configurations of optical traps (see U.S. Pat. No. 6,055,106 incorporated by reference herein). These DOEs tend not to be ideally efficient at converting an input laser beam into the desired pattern or configuration of traps. In fact the undiffracted portion of the input beam tends to be brought to a focus, and for most cases forms an optical trap in the midst of the desired optical trapping pattern. In general, this “central spot” from the undiffracted portion of the laser beam can constitute a far stronger optical trap than any of the other optical traps in the configuration. The result is that the central spot can disrupt the desired trapping pattern and interfere with its intended operation.

There have been some attempts in the prior art to overcome the resulting problems from such a central spot. In one example, the optical train is adjusted so that the undiffracted beam falls outside of the lens' field of view and is collected on an aperture. This conventional arrangement, however, is difficult to align, and has the additional drawback that the intended traps must be displaced far from the optical axis. Such displacement leads to severely degraded performance in practice. Another prior art approach involves blocking the undiffracted beam with a spatial filter at some point in the optical train. Such a spatial filter, however, also blocks parts of the field of view so that optical traps cannot be placed at those locations. Other prior art implementations also involve placing optical elements in the beam that would degrade trapping performance in various ways.

In yet another aspect of the invention, FIG. 1 illustrates prior art methods and systems in which optical gradient forces exerted by a single beam of light 12 are used to controllably manipulate a small dielectric particle 14 dispersed in a medium 16 whose index of refraction, nₘ, is smaller than that of the particle 14 at optical frequencies. The nature of the optical gradient forces is well known, and also it is well understood that the principle has been generalized to allow manipulation of reflecting, absorbing and low dielectric constant particles as well. Any of these conventional techniques can be implemented in the context of the invention described hereinafter and will be encompassed by use of the terminology optical tweezer, optical trap and optical gradient force trap hereinafter.

The optical tweezer system 10 is applied by using a light beam 12 (such as a laser beam) capable of applying the necessary forces needed to carry out the optical trapping effect needed to manipulate a particle. The object of a conventional form of the optical tweezer 10 is to project one or more beams of light into the center of a back aperture 24 of a converging optical element (such as an objective lens 20). As noted in FIG. 1 the light beam 12 has a width, w, and has an input angle φ relative to an optical axis 22. The light beam 12 is input to a back aperture 24 of the objective lens 20 and output from a front aperture 26 substantially converging to a focal point 28 in focal plane 30 of imaging volume 32 with the focal point 28 in near association with an optical trap 33. In general, any focusing optical system can form the basis for the optical tweezer system 10.

In the case of the light beam 12 being a collimated laser beam and having its axis coincident with the optical axis 22, the light beam 12 enters the back aperture 24 of the objective lens 20 and is brought to a focus in the imaging volume 32 at the center point c of the objective lens' focal plane 30. When the axis of the light beam 12 is displaced by the angle φ with respect to the optical axis 22, beam axis and the optical axis 22 coincide at the center point B of the back aperture 12. This displacement enables translation of the optical trap across the field of view by an amount that depends on the angular magnification of the objective lens 20. The two variables, angular displacement φ and varying convergence of the light beam 12, can be used to form the optical trap at selected positions within the imaging volume 32. A plurality of the optical traps 33 can be arranged in different locations provided that multiple beams of light 12 are applied to the back aperture 24 at different angles φ and with differing degrees of collimation.

In order to carry out optical trapping in three dimensions, optical gradient forces created on the particle to be trapped must exceed other radiation pressures arising from light scattering and absorption. In general this necessitates having the wave front of the light beam 12 to have an appropriate shape at the back aperture 24. For example, for a Gaussian TEMₒₒ input laser beam, the beam diameter w should substantially coincide with the diameter of the back aperture 24. For more general beam profiles (such as Laguerre-Gaussian modes) comparable conditions can be formulated.

In another prior art system in FIG. 2 the optical tweezer system 10 can translate the optical trap 33 across the field of view of the objective lens 20. A telescope 34, or other relay optics, is constructed of lenses L1 and L2 which establishes a point A which is optically conjugate to the center point B in the prior art system of FIG. 1. In other forms of the invention the relay optics can include other conventional systems, such as multiple optical elements to minimize aberrations. In the system of FIG. 2 the light beam 12 passing through the point A also passes through the point B and thus meets the basic requirements for performing as the optical tweezer system 10. The degree of collimation is preserved by positioning the lenses L1 and L2 as shown in FIG. 2. The transfer properties of the telescope 34 can be chosen to optimize angular displacement of the light beam 12 and its width w in the plane of the back aperture 24 of the objective lens 20. As stated hereinbefore, in general several of the light beams 12 can be used to form several associated optical traps. Such multiple beams 12 can be created from multiple independent input beams or from a single beam manipulated by conventional reflective and/or refractive optical elements.

In another prior art system shown in FIG. 3, arbitrary arrays of optical traps can be formed. A diffractive grating pattern 40 is disposed substantially in a plane 42 conjugate to back aperture 24 of the objective lens 20. Note that only a single diffracted output beam 44 is shown for clarity, but it should be understood that a plurality of such beams 44 can be created by the diffractive grating pattern 40. The input light beam 12 incident on the diffractive grating pattern 40 is split into a pattern of the output beams 44 characteristic of the nature of the diffractive grating pattern 40, each of which emanates from the point A. Thus the output beams 44 also pass through the point B as a consequence of the downstream optical elements described hereinbefore.

The prior art diffractive grating pattern 40 of FIG. 3 is shown as being normal to the input light beam 12, but many other arrangements are possible. For example, in the prior art system of FIG. 4 the light beam 12 arrives at an oblique angle β relative to the optic axis 22 and not at a normal to the diffractive grating pattern 40. In this embodiment, the diffracted beams 44 emanating from point A will form optical traps 50 in focal plane 52 of the imaging volume 32 (seen best in FIG. 1). In this arrangement of the optical tweezer system 10 an undiffracted portion 54 of the input light beam 12 can be removed from the optical tweezer system 10. This configuration thus enables processing less background light and improves efficiency and effectiveness of forming optical traps.

The diffractive grating pattern 40 can include computer generated holograms which split the input light beam 12 into a preselected desired pattern. Combining such holograms with the remainder of the optical elements in FIGS. 3 and 4 enables creation of arbitrary arrays in which the diffractive grating pattern 40 is used to shape the wavefront of each diffracted beam independently. Therefore, the optical traps 50 can be disposed not only in the focal plane 52 to form a three-dimensional arrangement of the optical traps 50.

In the optical tweezer system 10 of FIGS. 3 and 4, also included is a focusing optical element, such as the objective lens 20 (or other like functionally equivalent optical device, such as a Fresnel lens) to converge the diffracted beam 44 to form the optical traps 50. Further, the telescope 34, or other equivalent transfer optics, creates a point A conjugate to the center point B of the previous back aperture 24. The diffractive grating pattern 40 is placed in a plane containing point A.

In another form of prior art system, arbitrary arrays of the optical traps 50 can be created without use of the telescope 34. In such an embodiment the diffractive grating pattern 40 can be placed directly in the plane containing point B.

In the optical tweezer system 10 either static or time dependent diffractive grating patterns 40 can be used. For a dynamic, or time dependent version, one can create time changing arrays of the optical traps 50 which can be part of a system utilizing such a feature. In addition, these dynamic optical elements 40 can be used to actively move particles and matrix media relative to one another. For example, the diffractive grating pattern 40 can be a liquid crystal phase modulating array that imprints computer generated holographic patterns onto incident light.

In another prior art system illustrated in FIG. 5, a system can be constructed to carry out continuous translation of the optical tweezer trap 50. A gimbal mounted mirror 60 is placed with its center of rotation at point A. The light beam 12 is incident on the surface of the mirror 60 and has its axis passing through point A and will be projected to the back aperture 24. Tilting of the mirror 60 causes a change of the angle of incidence of the light beam 12 relative to the mirror 60, and this feature can be used to translate the resulting optical trap 50. A second telescope 62 is formed from lenses L3 and L4 which creates a point A′ which is conjugate to point A. The diffractive grating pattern 40 placed at point A′ now creates a pattern of diffracted beams 64, each of which passes through point A to form one of the tweezer traps 50 in an array of the optical tweezers system 10.

In operation of the embodiment of FIG. 5, the mirror 60 translates the entire tweezer array as a unit. This methodology is useful for precisely aligning the optical tweezer array with a stationary substrate, for dynamically stiffening the optical trap 50 through small-amplitude rapid oscillatory displacements, as well as for any applications requiring a general translation capability.

The array of the optical traps 50 also can be translated vertically relative to the sample stage (not shown) by moving the sample stage or by adjusting the telescope 34. In addition, the optical tweezer array can also be translated laterally relative to the sample by moving the sample stage. This feature would be particularly useful for large scale movement beyond the range of the objective lens' field of view.

In another prior art system shown in FIG. 6 the optical system is arranged to permit viewing images of particles trapped by the optical tweezers 10. A dicbroic beamsplitter 70, or other equivalent optical beamsplitter, is inserted between the objective lens 20 and the optical train of the optical tweezer system 10. In the illustrated embodiment the beamsplitter 70 selectively reflects the wavelength of light used to form the optical tweezer array and transmits other wavelengths. Thus, the light beam 12 used to form the optical traps 50 is transmitted to the back aperture 24 with high efficiency while light beam 66 used to form images can pass through to imaging optics (not shown).

A prior art application of optical traps is shown in FIGS. 7A and 7B. The diffractive grating pattern 40 is designed to interact with the single light beam 12 to create a 4×4 array of collimated beams. A 100 mW frequency doubled diode-pumped Nd:YAG laser operating at 532 NM provides a Gaussian TEMₒₒ form for the light beam 12. In FIG. 7A the field of view is illuminated in part by laser light backscattered by sixteen silica spheres trapped in the array's sixteen primary optical tweezers 10. The 1 μm diameter spheres are dispersed in water and placed in a sample volume between a glass microscope slide and a 170 μm thick glass coverslip. The tweezer array is projected upward through the coverslip and is positioned in a plane 8 μm above the coverslip and more than 20 μm below the upper microscope slide. The silica spheres are stably trapped in three dimensions, each in one of the sixteen optical tweezers 10.

In FIG. 7B is shown the optically-organized arrangement of spheres 1/30 second after the optical tweezers 10 (traps) were extinguished but before the spheres had time to diffuse away from the trap site.

Consequently, optical tweezers and related optical traps use forces exerted by the intensity gradients in tightly focused beams of light to trap, move and otherwise modify small volumes of matter in three dimensions. Imprecise alignment, and imperfect characteristics of the optical elements of an optical trapping system introduces aberrations into the trapping beam, diminishes its intensity gradients, and thereby degrades its ability to manipulate matter. In common practice, the optical elements in optical trapping systems are aligned by systematically adjusting each element's position while observing the apparent quality of the focused optical trap using an optical imaging system. A well aligned optical tweezer comes to a tight and symmetric focus and spreads uniformly and symmetrically when defocused. While simple and reasonably effective, this approach does not generally achieve optimal performance, nor does it provide a quantitative assessment of the optical train's alignment.

### SUMMARY OF THE INVENTION

It is therefore an object of the invention to provide an improved method and system for establishing a plurality of substantially aberration free optical traps.

It is another object of the invention to provide a novel method and system for using a method for correcting aberrations and/or anomalies in an optical train.

It is an additional object of the invention to provide a novel method and apparatus for using computer software to correct aberrations in an optical train including minimizing effects of a substantially undiffracted input beam

Control of Undiffracted Input Beam Effects

In a method of another embodiment of the invention, the optical train is focused so that both the diffracted and the undiffracted input beam are slightly converging (or slightly diverging) at the input pupil, and these beams then come to a focus upstream (or downstream) of the focal plane. The desired pattern of optical traps then can be operated on and projected downstream (or upstream) of this spurious undiffracted beam's focal spot. In general, such corrective axial displacement of the trapping pattern can be accomplished by integrating the phase function for a Fresnel lens into the pattern-forming DOE. The overall focus of the optical train thus can be adjusted to move the diffracted portion so that the undiffracted beam spot is buried in a user-selected location, such as one of the sample container's glass surfaces. Therefore, the intended traps are projected into the sample for the intended use. The user selected location for the undiffracted portion can be positioned virtually anywhere as permitted by the optics of the system. Some light from the undiffracted spot still will be projected into the sample, but will be sufficiently diffuse as to exert no significant optical forces on the sample, thereby enabling control and diminution of the unwanted effects from the undiffracted beam.

Another method of the invention for diminishing the effects of the undiffracted input beam on the desired optical trapping pattern is to arrange selected ones of the components of the optical train so as to introduce controlled aberration into the entire beam of light. The aberration can be introduced so that the diffracted beam can be moved where needed, while the optical gradient of the undiffracted input beam in the focal plane is sufficiently degraded so as to exert no significant optical forces on the sample being manipulated by the optical trap(s). The aberration introduced into the diffracted portion of the input beam (the desired optical trapping pattern) is therefore corrected using an encoded aberration correction integrated into the pattern-forming DOE as described hereinbefore. In one example, this can be achieved by arranging the components of the optical train so as to introduce the desired amounts of spherical aberration, coma, astigmatism, field curvature, distortion, or any combination of these into the diffracted beam and undiffracted input beam. In this form of the invention, a portion of the undiffracted beam is still present in the focal plane of the optical trapping pattern, even though its quality is degraded. The desired optical trapping pattern therefore goes through a process of first being degraded (along with the undiffracted beam) and then the diffracted beam corrected, instead of being displaced upstream (or downstream) from the focus of the undiffracted beam.

The above-described methods of controlling the substantially undiffracted beam relative to the diffracted beam has advantageous benefits. For instance, the undiffracted input beam can be left in a focused position at the interface between a glass surface and the sample to determine the absolute position of the glass-sample interface. Once established, this sets the absolute location of the intended trapping pattern relative to this interface. This knowledge can be useful in many applications of holographic optical tweezers.

It is a further object of the invention to provide an improved method and system for establishing a plurality of substantially aberration free optical traps for a variety of commercial applications relating to manipulation of small particles such as in photonic circuit manufacturing, nanocomposite material applications, fabrication of electronic components, opto-electronic devices, chemical and biological sensor arrays, assembly of holographic data storage matrices, facilitation of combinatorial chemistry applications, promotion of colloidal self-assembly, and the manipulation of biological materials.

It is still another object of the invention to provide an improved method and system for constructing a temporally and spatially varying configuration of optical gradient fields corrected for aberrations to meet various commercial application requirements.

It is also an object of the invention to provide a novel method and system for using an encoded phase shifting pattern applied to a pattern of optical traps for correcting for aberration effects.

It is yet a further object of the invention to provide an improved method and system using a single input laser beam, a diffractive grating pattern, a converging lens and an encoded aberration correction pattern to form a substantially aberration free static and/or dynamic optical trap.

It is also a further object of the invention to provide an improved method and system employing a laser beam input to a diffractive grating pattern and further using an aberration correction pattern with a beam scanning system enabling scanning of an array of optical traps for various commercial applications.

It is also yet another object of the invention to provide an improved method and system for employing a light beam, diffractive optics and an aberration correction system in conjunction with a plurality of telescope lenses to scan an optical trap array while maintaining substantially aberration free traps.

It is another object of the invention to provide a novel method for creating multiple independently steered optical traps using a time-dependent addressable phase-shifting medium (such as a liquid crystal phase shifting array) as a diffractive grating pattern and also to encode an aberration correction pattern with that medium.

Other objects, features and advantages of the present invention will be readily apparent from the following description of the preferred embodiments thereof, taken in conjunction with the accompanying drawings described below wherein like elements have like numerals throughout.

### BRIEF DESCRIPTION OF THE DRAWINGS

FIG. 1 illustrates a prior art method and system for a single optical tweezer;

FIG. 2 illustrates a prior art method and system for a single, steerable optical tweezer;

FIG. 3 illustrates a prior art method and system using a diffractive grating pattern;

FIG. 4 illustrates another prior art method and system using a tilted optical element relative to an input light beam;

FIG. 5 illustrates a prior art system with a continuously translatable optical tweezer (trap) array using a diffractive grating pattern;

FIG. 6 illustrates a prior art method and system for manipulating particles using an optical tweezer array while also forming an image for viewing the optical trap array;

FIG. 7A illustrates an image of a four by four array of optical tweezers (traps) using the prior art optical system of FIG. 6; and FIG. 7B illustrates an image of one micrometer diameter silica spheres suspended in water by the optical tweezers of FIG. 7A immediately after the trapping illumination has been extinguished, but before the spheres have diffused away.

FIG. 8A illustrates a calculated image of an ideal optical vortex with topological charge l=100; FIG. 8B illustrates a calculated image of the same vortex of FIG. 8A, but with the center of the diffractive grating pattern encoding the vortex displaced by 5 percent of its aperture diameter; and FIG. 8C illustrates a more extreme displacement of the vortex-forming phase mask from the optical axis, in this case 10 percent of the aperture diameter;

FIG. 9A shows an undistorted vortex; FIG. 9B shows a vortex suffering from 10λ of spherical aberration; FIG. 9C shows the influence of 10λ coma aberration; FIG. 9D shows the influence of 10λ of astigmatism; FIG. 9E shows the influence of 10λ of field curvature; and FIG. 9F shows the influence of 10λ of pincushion distortion; and

FIG. 10 is a schematic diagram of a dynamic holographic optical tweezer system.

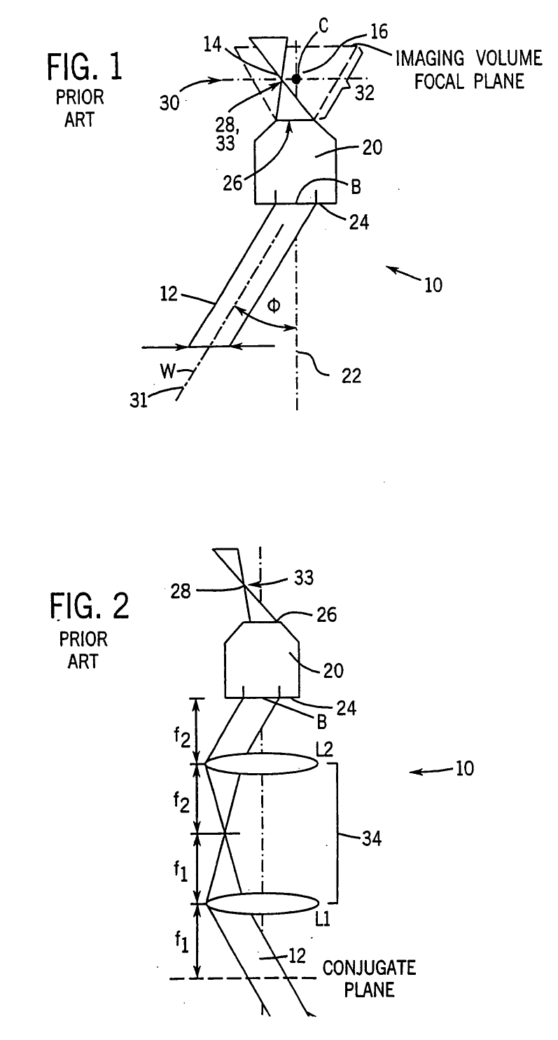

### DETAILED DESCRIPTION OF THE PREFERRED EMBODIMENTS

In a preferred form of the invention, gradient force optical traps, such as holographic optical tweezers, are advantageously modified to overcome a variety of optical aberrations. However, as will be described hereinafter, the method and system can be applied to a variety of optical systems. In the preferred form of the invention, forces are exerted by strongly focused beams of light to form optical traps to precisely manipulate small volumes of matter. Optimal trapping requires each beam of light to be brought to a diffraction-limited focus. Aberrations degrade the quality of focus and thereby degrade the ability of the resulting focused beam of light to operate as a trap.

This invention is directed toward correcting the aberrations in one or more beams of light so as to optimize optical trapping. The particular implementation involves calculating a phase-shifting diffraction grating encoding the corrections to measured aberrations, and projecting this diffraction grating in conjunction with another diffraction grating encoding a pattern of one or more optical traps. In practice, the combined diffraction gratings can be projected with a computer-addressable device such as a phase-only spatial light modulator (SLM) and so would provide a means for dynamically correcting aberrations in a dynamic holographic optical tweezer system.

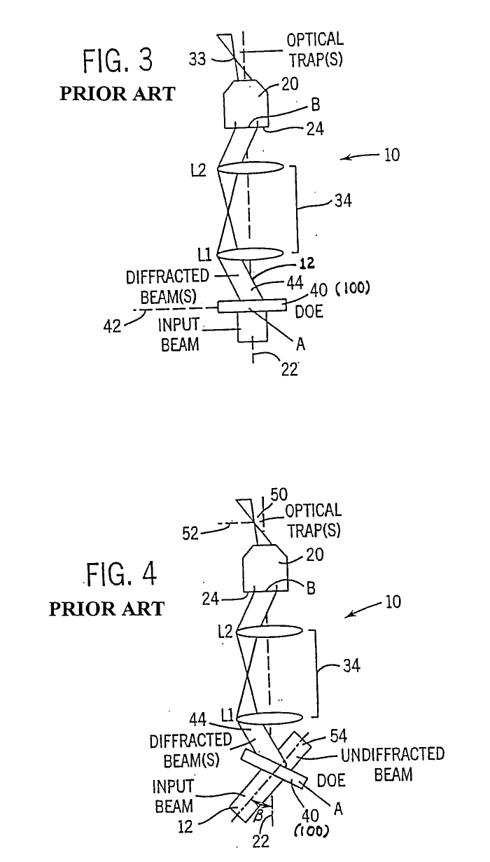

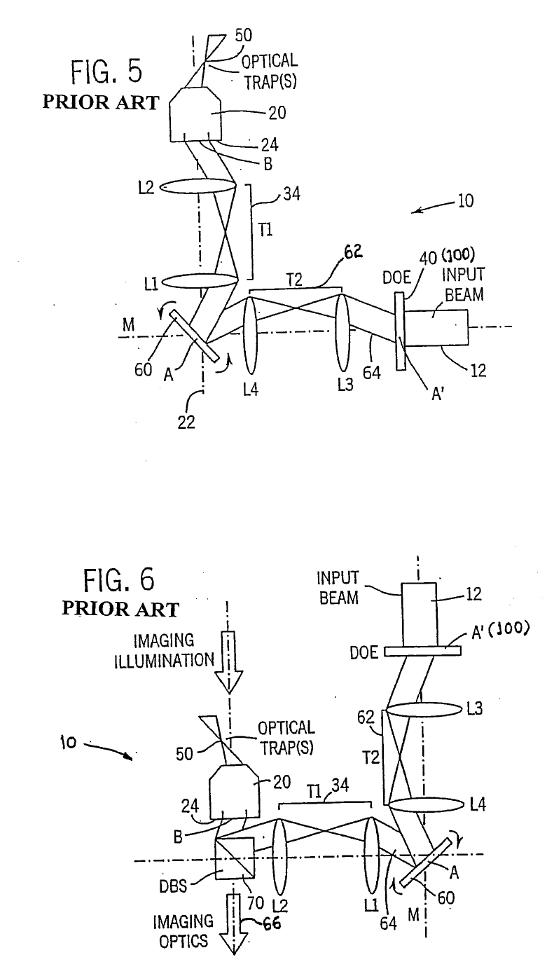

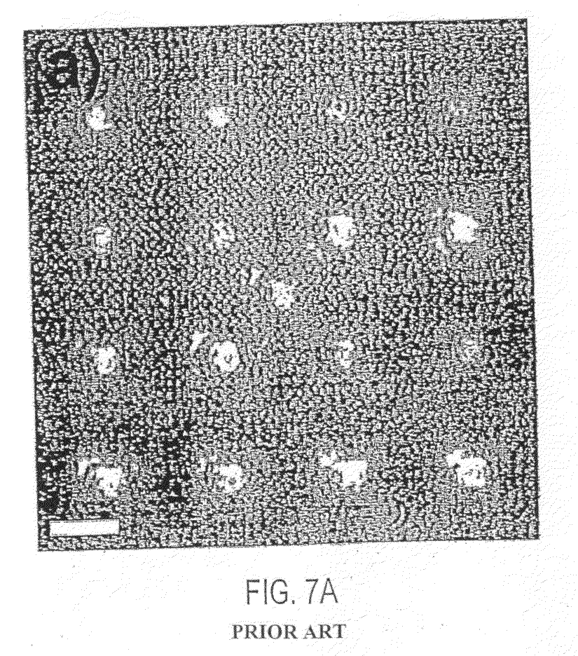

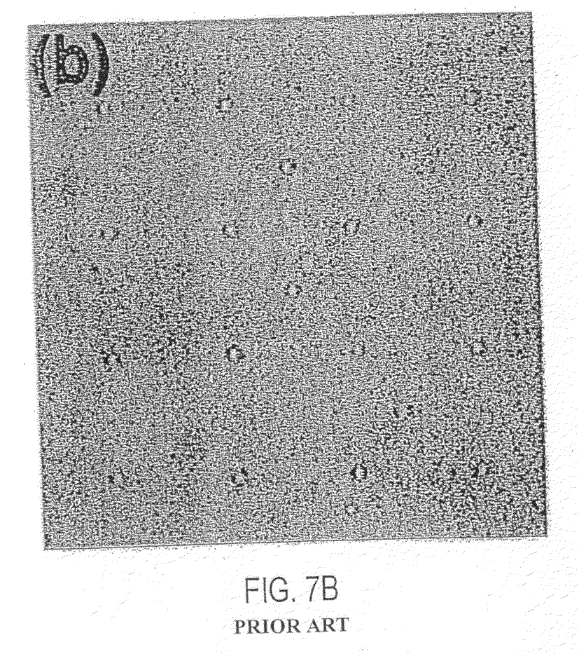

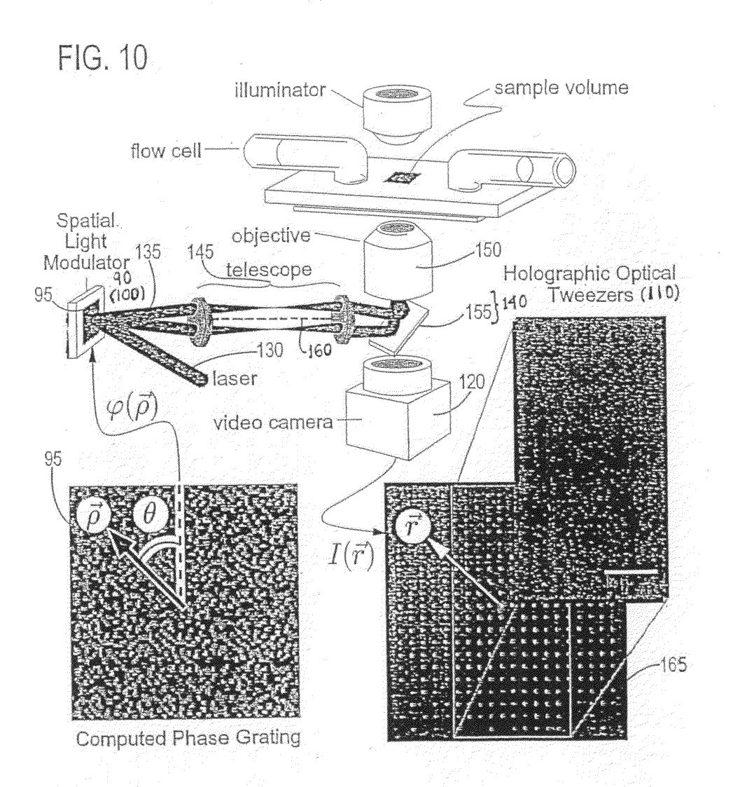

The use of computer-generated diffractive grating patterns (DOE) to create one or more optical traps and to imbue each with distinctive characteristics is known as the holographic optical tweezer (hereinafter, HOT) technique. Projecting diffractive grating patterns with an updateable device such as an SLM 90 (see FIG. 10), makes possible additional manipulations and distinguishes the dynamic holographic optical tweezer technique from static HOTs. The present invention is most preferably applied to dynamic HOTs. In a system using a static but removable DOE, we can replace the DOE with a static vortex-forming phase mask 100 (see FIG. 10 and in phantom is FIGS. 3-6). The image of the resulting vortex can be used to compute the correcting phase mask 100 for that particular optical train. The optimizing phase mask 100 can be used to compute other static DOE's or can be fabricated and incorporated into the optical train, much as a Schmidt corrector is used in some reflecting telescopes. The phase mask 100 can take on any well known conventional form such as replacing the various DOE components (40 in FIGS. 3-5 or A in FIG. 6) with two DOEs placed back to back. One of the DOEs can be the trap forming component, and the other DOE can be the aberration correcting component. The pairs of DOEs preferably are placed in close proximity and in any order.

The five principal aberrations in a beam of light are characterized as spherical aberration, coma, astigmatism, field curvature and distortion. These may be introduced into an otherwise ideal beam of light by slight misalignment of the components of an optical train such as the relay lenses and focusing element in the HOT system 110 (see FIG. 10). Describing the wavefront of a beam of light 130 by its complex-valued field

ψ[S]=A[S]exp(iφ[S])), (1)

where A[S] is the real-valued amplitude and φ[S] is the real-valued phase, any aberrations in the beam of light 130 may be described as spatial variations in [S] across the beam's aperture.

Without loss of generality, we may characterize the unaberrated beam as a collimated plane wave with constant phase across its wavefront. Introducing the five primary aberrations one can therefore use conventional formalities applied to this wavefront:

φₐ[S]=(a□/2^{1/2})(6ρ⁴−5ρ²+1) spherical aberration (2)

a₁,((3ρ³−2ρ)cos(θ−θ₁) coma (3)

+a₂ρ²└2 cos²(θ−θ₂)−1┘ astigmatism (4)

+a₃/2^{1/2})(2ρ²−1) field curvature (5)

a₄ρ cos(θ−θ₄) distortion (6)

Here, ρ=r/a is the radius from the beam's axis in units of the aperture's radius, a, and θ is the polar angle in the plane of the wavefront. The five coefficients, a₀ through a₄, and the associated angles θ₁, θ₂ and θ₄ completely specify the beam's aberrations.

These coefficients and angles can be measured by projecting one or more optical traps using the HOT system 110 and creating images of the resulting light using an imaging system such as a video camera 120. Multiplying each of the coefficients by −1 results in a new aberration pattern φ_{C}[S] which exactly counteracts the aberrations already in the beam. Projecting φ_{C}[S] with the SLM 90 in a dynamic HOT system therefore will correct the aberrations in the beam of light 130 and result in an unaberrated form of optical trap.

The aberration-correcting phase mask 100 can be combined with other trap-forming diffraction patterns to improve those patterns' trapping abilities. For example, consider a phase pattern φ_{C}[S] encoding a particular pattern of traps. When projected through the HOT optical system 110, the resulting traps all will be degraded by aberrations introduced by the optical train. The combination

φ[S]=[φ₀[S]+φ_{C}[S]] mod 2π (7)

projects the same pattern of traps, but with their aberrations corrected. Here, the mode operator represents the scaling and discretization needed to encode the phase pattern on the face of the SLM 90.

The same composition of phase patterns can be used to correct any trapping pattern projected with the HOT system 110. Consequently, the combination of one-time calibration and per-use, correction offers a straight-forward means to correct for physically-introduced aberrations under software control without aligning or otherwise adjusting the physical components of the optical train of the HOT system 110. Such calibration can be repeated periodically to maintain optimal aberration correction even as physical components' alignment drifts over time. Dynamically fine-tuning optical alignment under software control offers the additional benefit of relaxed manufacturing tolerances and maintenance schedules on commercial HOT systems.

The preferred form of the invention is concerned with a quantitative approach to aligning optical trapping systems, and in particular those incorporating the SLM 90 or other optical elements capable of shaping the mode of the trapping light. This method will be particularly useful for aligning dynamic holographic optical tweezers.

A preferred form of the invention involves projecting a mode of light such as an optical vortex whose appearance depends obviously and sensitively on defects in alignment. An optical vortex is a mode of light used in optical tweezers for various applications, including trapping and manipulating optically absorbing materials. An optical vortex is created by modifying the phase profile of the incident laser beam of light 130 with a phase-shifting form of optical element (namely, the phase mask 100, such as a modified form of the computer-generated DOE 140 applied by using the SLM 90).

The incoming laser wavefront is described by its complex-valued field

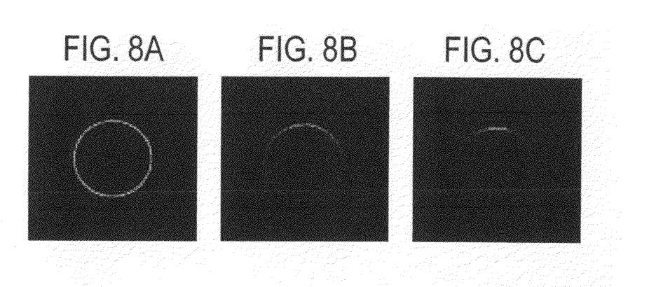

ψ[S]=A[S]exp(iφ[S])), (1)

where A[S] is the real-valued amplitude and φ[S] is the real-valued phase at position [S] relative to the system's optical axis in the DOE plane. The phase modulation encoding an ideal optical vortex is φ[S]=lθ where θ is the polar angle in the DOE plane relative to an arbitrary but fixed direction, and l is an integer known as the topological charge. Because of the destructive and constructive interference mediated by this phase modulation, an optical vortex appears in the focal plane of an system 110 as a donut ring of light approximately as thick as λ, the wavelength of light, and with a radius R proportional to the topological charge l. A typical example of the optical intensity pattern of an optical vortex in the focal plane of the HOT system 110 is shown in FIG. 8A.

An ideal optical vortex in a perfectly aligned optical trapping system with an axially symmetric Gaussian input laser beam should appear evenly illuminated, perfectly circular and centered with respect to an optical tweezer projected with the same system by setting φ[S]=0. Focusing up and down through the vortex should reveal a growing and blurring circle, concentric with the focused vortex. The structure of an optical vortex depends sensitively on details of the phase function φ[S]. Imperfections in the optical train, such as misalignment of optical elements modifies the phase profile and thus the vortex's appearance. For example, if the phase modulation φ[S] encoding the optical vortex in the phase mask 100 is not centered on the optical axis (such as, for example, because the SLM 90 is misaligned) the vortex's uniform circular appearance degrades into an asymmetric pattern of bright and dark regions, as shown in FIGS. SB and BC. Such misalignment would not be readily observed in the properties of optical tweezers projected with the same system, but nonetheless would degrade performance, particularly for complicated optical trapping patterns.

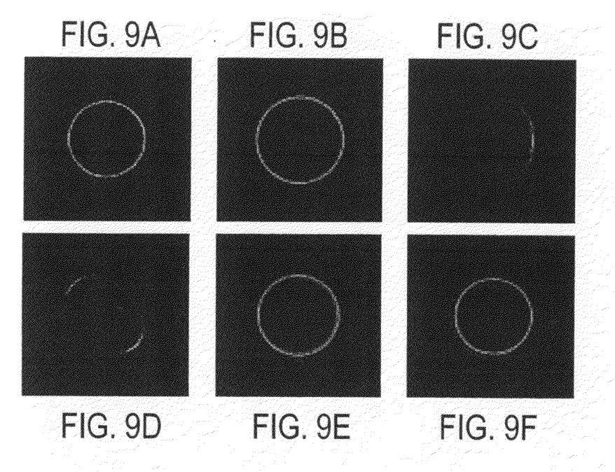

Other misalignments within the optical train introduce aberrations into the beam and manifest themselves in characteristic distortions of the projected vortex's appearance, as shown in FIGS. 9A-9F. The five principal aberrations affecting an optical train in the system 110, such as shown in the example HOT system in FIG. 10, include coma, astigmatism, spherical aberration, curvature of field, and distortion. There are other conventional aberrations and they can in this manner be treated in accordance with the methods described herein.

Each aberration component has its own particular signature in the structure of a projected optical vortex. Spherical aberration increases the vortex's diameter and reduces its axial intensity gradients, as shown in FIG. 9B. In yet another aberration effect, coma distorts the vortex away from circularity and redistributes light so that one side is brighter than the other, as in FIG. 9C. Unlike coma, astigmatism distorts a vortex into a symmetric ellipse and redistributes its intensity symmetrically, as shown in FIG. 9D. Curvature of field redistributes a vortex's intensity along the radial direction, as shown in FIG. 9E and also reduces the intensity along the radial direction. The typical abrupt change to maximum intensity is softened. Finally, distortion shills the center of the vortex away from the optical axis as shown in FIG. 9F. This is a slightly more difficult aberration to identify in that its influence resembles that due to centration errors. However, the shift due to distortion does not affect the intensity distribution around the ring, and so it can be distinguished from degradation due to centration errors.

Each of these distortions can be measured from images of projected vortices more accurately than can their more subtle counterparts in images of conventional optical tweezers. Furthermore, these distortions can be measured quantitatively with a conventional computer imaging system. The results can be used to improve the alignment of the various physical optical elements in the HOT system 110. Alternatively, and preferentially, the measured distortions can be corrected in software by computing the phase mask 100 which exactly compensates for the measured defects. The resulting aberration-correcting phase mask 100 can be incorporated into other DOE's encoding desired arrangements of optical traps. In this way, the aberration-correcting phase mask 100 will correct the aberrations in the DOE-produced traps and thereby improve their performance.

Aberration measurement and compensation can be accomplished automatically by alternately projecting modified vortex patterns and measuring the resulting intensity distribution under computer control.

As an example of this approach's utility, we discuss its use for aligning the particular HOT system 110, shown schematically in FIG. 10. The aligned components include the laser beam of light 130, the SLM 90, transfer optics 140, and microscope objective 150. Ideally, the laser beam of light 130 can be in a single Gaussian mode or some other well known mode which is symmetric about optical axis 160. This insures that when the system 110 is perfectly aligned, the intensity around a projected optical vortex's circumference will be constant. When the optical train is aligned, the beam of light 130 strikes the center of the SLM 90, passes along the optical axis 160 through the center of each lens in the transfer optics 140, enters the back aperture of the objective lens 150 centered, and just slightly overfills the lens' input pupil.

In FIG. 10 a collimated laser beam of light 130 is incident on the front face of the computer-addressed SLM 90. The phase modulation 95 φ[S] imparted by this SLM 90 onto the beam's wavefront splits the single input beam of light 130 into multiple beams of light 135, each with individually specified characteristics. These multiple beams 135 are relayed by two lenses 145 in a telescope configuration to the back aperture of a high-numeric-aperture focusing element, here depicted as the microscope objective lens 150 (although any conventionally available focusing element can be used). The lens focuses each beams into a separate optical trap. The projected light 135 can be focused onto the surface of a mirror placed temporarily in the sample plane. Light reflected by the mirror is collected by the same objective lens 150, passes through a dichroic mirror 155 and forms an image 165 on the attached CCD camera 120. This makes possible direct measurement of the intensity I[S] of light in the focal plane.

Any deviation from ideal alignment is easily detected in the appearance of an optical vortex. For instance, imprecise alignment of the relay lenses 145 relative to the optical axis results in coma, and would degrade a projected vortex as in FIGS. 8B, 8C and 9B-9F. Tilting the lenses 145 relative to the optical axis introduces astigmatism, which has a different appearance. Imperfect surface figures on the lenses 145 or the SLM 90 can introduce distortion or spherical aberration, each of which has its characteristic appearance. These defects' influence on a vortex's image need not combine linearly. Even so, a nonlinear iterative search algorithm can be used to fit an image of a distorted vortex to a model incorporating the effects of centration error and the five principal aberrations. The parameters obtained from such a fit can be used to offset computer-generated holograms to compensate for centration error and to compute the best phase mask 95 to correct for other aberrations. The success of this method and system can be gauged by projecting nominally corrected optical vortices and characterizing their distortions.

In a most preferred embodiment a particular order of performing the aberration correction involves the following series of steps:

Locate the Optical Axis on the Video Camera: Send a uniform phase pattern such φ[S]=0 to the SLM 90. This results in a single undiffracted beam being projected by the SLM 90 onto the mirrored surface of the mirror 155, and thence back onto the video camera 120. The location of this beam on the face of the video camera 120 defines the location of the optical axis. We will refer to this position as [S]₀=(X₀, Y₀, 0).

The intensity of the input laser beam 130 should be adjusted so that the undiffracted spot is visible on the camera 120, but does not saturate it. If the undiffracted spot cannot be located in the field of view, then the optical train is too far out of alignment to proceed, and physical alignment is required.

Establish the Trapping System's Geometry: The spatial relationship between a designed trapping pattern and the projected result can be described by three parameters, a scaling factor mₓ in the [S] direction on the SLM 90, another scaling factor my in the [S] direction on the SLM 90, and a relative orientation θ between the SLM 90 and the video camera 120. We assume in this section that any distortion due to the imaging system have been previously measured and are corrected. The three parameters can be measured by sending a kirioform to the SLM 90, encoding a simple array of traps, such as a 4×4 square pattern, and imaging the resulting intensity in the focal plane using standard methods of digital video microscopy. In particular, we measure the positions of each of the projected traps based on the center of intensity for each focused spot of light. The traps' relative separations can be analyzed using methods of computation geometry to derive the scale factors, mₓ and m_{y} and the orientation [S]. The two scale factors need not to be identical if the SLM 90 is aligned at an oblique angle with respect to the incident laser beam 130, as is necessary in some optical tweezer implementation. If normal incidence is desired in another implementation, a determination that mₓ and m_{y} are not equal can be used to measure the SLM's inclination with respect to the optical axis.

For this operation, the intensity of the input laser beam 130 should be adjusted so that the diffracted spots are visible on the video camera 120, but do not saturate it. Once the scale factors and orientation are known, they can be used to place traps precisely in the field of view and to remove distortions in the trapping patterns due to the SLM's alignment relative to the optical axis.

Locate the Optical Axis on the SLM: Once the center of the field of view and the scaling factors have been established, they can be used to locate where the optical axis passes through the face of the SLM 90. To do this, we transmit a kinoform to the SLM 90 encoding an optical vortex, taking into account any scale-factor corrections due to oblique incidence of the laser beam on the SLM's face. For an optical train in which mₓ=m_{y}, the phase pattern φ[S]=lθ converts a Gaussian input laser beam into a Laguerre-Gaussian beam with topological charge l which is focused into a corresponding optical vortex trap. This pattern is modified in a straightforward manner to account for any asymmetry revealed in the previous step.

When the optical train is properly aligned, an optical vortex should focus to an annular intensity pattern centered on the optical axis with uniform intensity around the circumference. If the center of the phase pattern is not aligned with the optical axis, however, then the ring of light focuses to a distorted annulus with nonuniform intensity. Translating the phase pattern on the face of the SLM 90 under software control can be used to optimize the projected vortex's circularity, centration on the optical axis at the video camera, and uniformity.

The offset ρ₀ in the SLM plane which optimizes the projected vortex's appearance may be identified as the location of the optical axis on the face of the SLM 90. This measurement may be used to adjust the physical position of the SLM 90 so that the optical axis is centered on its face. In that case, the previous two steps should be repeated.

Alternatively, the measured offset can be used to center other kinoforms on the SLM face so that their centers are aligned with the optical axis. This approach does not require any alteration of the physical apparatus and can be applied provided that the offset is not too large. Some combination of physical alignment and virtual alignment may provide the best results for a particular application.

Measure the Effective Input Aperture: The objective lens 150, the relay optics (the lenses 145) and the SLM 90 are combined into an optical train whose effective aperture may not be known a priori, or else may depend on details of the optical train's alignment. The aperture's radius R relative to the optical axis on the face of the SLM 90 can affect a kinoform's ability to create a desired trapping pattern, and ideally should be factored into the algorithm used to compute kinoforms for the system.

Once ρ₀ is determined in the previous step, a virtual aperture can be established by modifying the vortex-forming kinoform in the previous step by setting Φ₀[S]=Φ₀, where Φ₀ is a constant for |ρ-ρ₀|≧R. If R is larger than the physical effective aperture at the SLM plane, then this modification will not alter the appearance of the vortex in the video camera 130. Projecting such kinoforms in which R is reduced sequentially until a change in the projected vortex's appearance is visible can be used to establish the aperture radius.

If the aperture turns out to be comparable to the size of the SLM's face, then this should be used as both the size and shape of the effective aperture. Once the effective aperture has been measured, it can be used to calculate kinoforms optimized for this aperture. This value, together with the lengthscale calibration of the imaging system, is needed to calculate the expected appearance of an optical vortex. Deviations of the calculated and measured appearance can be used to gauge and correct for other defects in the optical train's alignment.

Measure and Correct for Spherical Aberrations: An optical vortex's appearance can be used to measure the previously described five principal aberrations to which the present class of optical trains may be subject. These aberrations may be introduced by misalignment of the relay optics, the lenses 145, for example through tilting or displacement of the individual lenses relative to the optical axis. They may be inherent in the input beam used to illuminate the SLM 90. In practice, they may be introduced by some combination of these.

Once the aberrations have been measured, their severity can be used to gauge whether or not the physical optical train requires realignment. If so, then all of the preceding steps would preferably be repeated. Alternatively, the measured aberrations can be used to calculate a compensating phase mask. This phase mask 95 can be combined with kinoforms encoding patterns of traps to correct the aberrations in the resulting trapping patterns.

The complexity of the compensating phase mask 95 will limit the complexity of the trapping patterns which can be projected with the system. Measuring the compensating phase mask's complexity, such as by examining its spatial correlation function, provides another way to determine whether or not the physical optical train requires realignment.

While adequate results might be obtained by analyzing the intensity distribution of a single optical vortex, repeating the measurement with a variety of vortices might well improve the accuracy of the distortion measurement and would highlight other imperfections such as nonuniform illumination which would not be addressed by the above analysis.

This technique also is a quick and easy method to study the profile of the incoming laser beam of light 130. Knowledge of this profile could allow for educated hardware adjustments to modify the beam. A knowledge of the incident beam profile is also very useful because the phase mask 100 used for the HOTs are created with an assumption of the beam profile, and they are most efficient if the correct beam profile is used. While other methods, such as imaging with the CCD camera 120, may allow similar analysis of the beam, this is non-invasive technique requires no extra equipment, setup time or a potential risk of disturbing the physical alignment during measurement.

While preferred embodiments have been illustrated and described, it should be understood that changes and modifications can be made therein in accordance with one of ordinary skill in the art without departing from the invention in its broader aspects. Various features of the invention are defined in the following claims.

What is claimed is:

1. A method of correcting for aberrations in a beam of light for creating an optical trap, comprising the steps of:
providing a beam of light;
applying a diffractive grating pattern to the beam of light to establish an optical gradient to form an optical trap;
measuring aberration in the beam of light having the applied diffractive grating pattern;
calculating a phase-shift correcting for the aberration; and
projecting the phase-shift in conjunction with the diffractive grating pattern characteristic of the optical trap, thereby correcting for the aberration.

2. The method as defined in claim 1, wherein the diffractive grating pattern is formed by the step of a computer executing a program to create a diffractive grating pattern.

3. The method as defined in claim 1, wherein the step of measuring aberration includes at least one of determining spherical aberration, coma, astigmatism, field curvature and distortion.

4. The method as defined in claim 1, wherein the projecting step includes using a computer addressable, phase-only spatial light modulator.

5. The method as defined in claim 4, wherein the method for correcting for aberration is performed dynamically for a dynamic holographic optical trap.

6. The method as defined in claim 1, wherein the aberration can be analytically characterized by determining spatial variations in real value phase, [S](r).

7. The method as defined in claim 6, wherein the real value phase, [S](r), comprises at least one of a set of additive aberration components:
(a) spherical aberration, (aₒ/2^{1/2})(6ρ²−5ρ²+1);
(b) coma, a₁,((3ρ³−2ρ)cos(θ−θ₁);
(c) astigmatism, +a₂ρ²└2 cos²(θ−θ₂)−1┘; (d) field curvature, (a₃/2^{1/2})(2ρ²−1); and
(e) distortion, a₄ρ cos(θ−θ₄),
where ρ=r/a, a radius from an axis of the light beam in units of radius of an aperture of a source of the light beam, a; and θ is a solar angle in a wavefront plane, with the coefficients (a₁, a₂, a₃, a₄ and a₅) and associated angles θ₁, θ₂ and θ₄ specifying the aberration.

8. The method as defined in claim 7, wherein the coefficients (a₁, a₂, a₃, a₄ and a₅) and the angles θ₁, θ₂ and θ₄ are determined by the steps of projecting the optical trap and creating images of resulting light via an imaging system.

9. The method as defined in claim 8, further including the step of multiplying each of the coefficients by −1 generate the phase-shifting diffraction grating.

10. The method as defined in claim 1, wherein the step of applying a diffraction grating pattern comprises modifying a phase profile of the beam of light by at least one of a diffractive grating pattern and a spatial light modulator.

11. The method as defined in claim 10, wherein the beam of light trap is formed into an optical vortex by a step of applying a dynamically changing diffraction grating pattern encoding an optical vortex.

12. The method as defined in claim 1, wherein the beam of light comprises a laser light.

13. A method of characterizing optical aberration in an optical train, comprising the steps of:
providing a beam of laser light to the optical train;
interacting the beam of laser light with a diffractive grating pattern in the optical train to form an optical trap; and
characterizing aberration in the optical train by the step of identifying aberration coefficients from an image of the optical trap.

14. The method as described in claim 13, wherein the optical trap comprises an optical vortex.

15. The method as defined in claim 13, wherein the step of characterizing aberration comprises determining spatial variations in real value phase, [S](r).

16. The method as defined in claim 15, wherein the real-value phase, [S](r), comprises at least one of a set of additive aberration components:
(a) spherical aberration, (aₒ/2^{1/2})(6ρ⁴−5ρ²+1);
(b) coma, a₁, ((3ρ³−2ρ)cos(θ−θ₁);
(c) astigmatism, +a₂ρ²└2 cos²(θ−θ₂)−1┘;
(d) field curvature, (a₃/2^{1/2})(2ρ²−1); and
(e) distortion, a₄ρ cos(θ−θ₄),
where ρ=r/a, a radius from an axis of the light beam in units of radius of an aperture of a source of the light beam, a; and θ is a solar angle in a wavefront plane, with the coefficients (a₁, a₂, a₃, a₄ and a₅) and associated angles θ₁, θ₂ and θ₄ specifying the aberration.

17. The method as defined in claim 16, wherein the coefficients (a₁, a₂, a₃, a₄ and a₅) and the angles θ₁, θ₂ and θ₄ are determined by the steps of projecting the optical trap and creating images of resulting light via an imaging system.

18. A system for correcting for optical aberration in an optical train, comprising:
means for providing a laser beam;
means for applying a diffraction pattern to the laser beam to establish an optical trap;
means for measuring optical features of an image of the optical trap;
computer means for executing a computer program to identify aberration characteristics of the optical trap from the optical features; and
computer means to generate a phase corrective mask to substantially remove the aberration in a resulting optical trap.

19. The system as defined in claim 18, wherein the means for applying a diffraction pattern comprises a wave front shaping device.

20. The system as defined in claim 18, wherein the means for applying a diffraction pattern comprises at least one of a diffractive grating pattern, a spatial light modulator, a micromirror array and a deformable mirror.

21. The system as defined in claim 18, wherein the optical trap is comprised of a plurality of different optical vortices, thereby improving accuracy of characterization of the optical aberration.

22. The system as defined in claim 18, further including means for projecting a sequence of optical vortices in a selectable manner.

23. A method of correcting for distortions in an input beam of light to create a substantially aberration free optical trap, comprising:
providing the input beam of light;
providing an optical train to operate on the input beam of light;
modifying a phase profile of the input beam of light with a diffractive optical element to apply a diffractive grating pattern to the input beam of light to generate an optical vortex;
projecting said optical vortex and measuring a distortion of said optical vortex using a computer imaging system; and
computing an aberration correcting phase mask which compensates for said distortion; and
correcting said aberration in said at least one optical trap using said aberration correcting phase mask.

24. The method as defined in claim 23, further comprising:
providing a lens encoded on the diffractive optical element to encode the diffractive grating pattern to act as said aberration correcting phase mask.

25. The method as defined in claim 24, wherein the encoding step is carried out by the step of a computer executing a program to create the encoded diffractive grating pattern.

26. The method as defined in claim 24, further including the step of projecting the encoded diffractive grating pattern using a computer addressable, phase-only spatial light modulator.

27. The method as defined in claim 26, wherein the method for correcting distortions in the input beam of light is performed dynamically for a dynamic holographic optical trap.

28. The method as defined in claim 23, wherein the modifying step includes integrating a phase function for a Fresnel lens into the diffractive grating pattern.

29. A system for correcting for distortions in an input beam of light to create a substantially aberration free optical trap, comprising:
a device for providing the input beam of light;
an optical train to operate on the input beam of light;
a diffractive optical element for establishing a diffractive grating pattern for operation on the input beam of light to generate an optical vortex;
means for projecting said optical vortex and means for measuring a distortion of said optical vortex;
means for computing an aberration correction phase mask which compensates for said distortion; and
means for correcting said aberration in said at least one optical trap.

30. The system defined in claim 29, wherein the correcting means comprises a Fresnel lens phase function integrated into the diffractive optical element.
